(19) United States
(12) Patent Application Publication
(10) Pub. No.: US 2014/0087212 A1
(43) Pub. Date: Mar. 27, 2014

(54) CARBON BLACK COMPOSITION, CARBON BLACK-CONTAINING COATING FILM, AND MAGNETIC RECORDING MEDIUM COMPRISING THE SAME

(71) Applicant: FUJIFILM Corporation, Tokyo (JP)

(72) Inventors: Takashi IMAI, Minami-ashigara-shi (JP); Kazufumi OMURA, Minami-ashigara-shi (JP)

(73) Assignee: FUJIFILM Corporation, Tokyo (JP)

(21) Appl. No.: 14/038,318

(22) Filed: Sep. 26, 2013

(30) Foreign Application Priority Data
Sep. 27, 2012 (JP) 2012-213646

(51) Int. Cl. C09D 7/12; G11B 5/733

(52) U.S. Cl. CPC C09D 7/1233; G11B 5/733
USPC 428/840.3; 106/287.3; 524/252; 106/287.24; 428/842

(57) ABSTRACT

The carbon black composition includes carbon black and an amine compound denoted by formula (1) in a solvent:

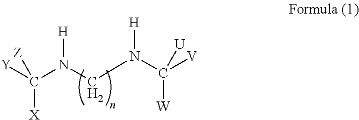

wherein, in formula (1), n denotes an integer falling within a range of 2 to 4, each of U, V, X, and Y independently denotes a substituent that comprises at least one carbon atom and binds, through the carbon atom, to a carbon atom to which the substituent substitutes, and each of W and Z independently denotes a hydrogen atom or a substituent.

### CROSS-REFERENCE TO RELATED APPLICATIONS

This application claims the benefit of priority under 35 USC 119 to Japanese Patent Application No. 2012-213646 filed on Sep. 27, 2012, which is expressly incorporated herein by reference in its entirety.

### BACKGROUND OF THE INVENTION

1. Field of the Invention

The present invention relates to a carbon black composition, and more particularly, to a carbon black composition capable of achieving a highly dispersed state of carbon black in solvent.

The present invention further relates to a carbon black-containing coating film obtained from the above carbon black composition and a magnetic recording medium comprising the above coating film.

2. Discussion of the Background

Carbon black is employed as a coloring material, electrically conductive material, filler and the like in various fields such as print ink, paints, cosmetics, and batteries. In the field of magnetic recording, carbon black is widely added to magnetic layers, nonmagnetic layers, backcoat layers, and the like to prevent static electricity, reduce the coefficient of friction, impart a light-blocking property, enhance film strength, and the like in magnetic tapes and disks.

As set forth above, carbon black is a useful material that is employed in various fields. However, it forms a high-order structure, known as a “structure,” that has an aggregating property in solvent. The more minute the particles, the more pronounced the above property becomes, entailing various problems. For example, in particulate magnetic recording media, when carbon black aggregates in the coating liquid, the smoothness of the coatings of magnetic layers and the like that are formed by coating and drying the coating liquid on a support is greatly compromised. When carbon black aggregates in a print ink, color irregularities and degradation of color tone result.

Thus, various attempts have been made to enhance the dispersion of carbon black in solvents (for example, see Japanese Patent No. 4,239,629 and Japanese Patent No. 3,646,507, which are expressly incorporated herein by reference in their entirety.

Carbon black is widely employed in various fields, and there is constant demand for enhanced dispersion (aggregation prevention). However, it has the special property of forming a structure. Thus, it is not easy to enhance the dispersion of carbon black. The dispersed state of carbon black that is achieved by conventional methods—in the field of magnetic recording, for example, where a high degree of coating smoothness is demanded to achieve higher density recording—is not necessarily adequate.

### SUMMARY OF THE INVENTION

An aspect of the present invention provides for a composition (carbon black composition) in which carbon black is highly dispersed in a solvent.

In Reference 1 (U.S. Pat. No. 4,239,629), it is stated that an amine compound comprising a secondary amino group decreases the dispersion of carbon black (see paragraph [0015] of Reference 1). Based on that information, in Reference 1, a diamine comprising a tertiary amino group is employed as a carbon black dispersing agent.

By contrast, the present inventors conducted extensive research. As a result, they discovered that although the use of an amine compound comprising a secondary amino group is negatively described in Reference 1, the diamine comprising a secondary amino group that is denoted by formula (1) set forth below can enhance the dispersion of carbon black in solvent.

This point will be described in greater detail. In an amine compound comprising a secondary amino group with little steric hindrance of the substituent adjacent to the nitrogen atom, chemical bonds tend to form and interaction tends to occur. These are thought to be what causes the decrease in the dispersion of carbon black in solvent that is described in Reference 1.

By contrast, the diamine denoted by formula (1) is structurally characterized by the high bulk of the substituent that has been substituted onto the nitrogen atom. The steric hindrance that is thus imparted can inhibit the formation of unneeded chemical bonds and interaction that would reduce dispersion. The present inventors presume that this is why the diamine denoted by formula (1) can enhance the dispersion of carbon black in solvent.

The present invention was devised on the basis of the above knowledge.

An aspect of the present invention relates to a carbon black composition, which comprises carbon black and an amine compound denoted by formula (1) in a solvent;

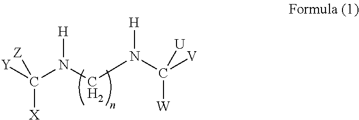

wherein, in formula (1), n denotes an integer falling within a range of 2 to 4, each of U, V, X, and Y independently denotes a substituent that comprises at least one carbon atom and binds, through the carbon atom, to a carbon atom to which the substituent substitutes, and each of W and Z independently denotes a hydrogen atom or a substituent.

In an embodiment, in formula (1), each of W and Z independently denote a substituent that comprises at least one carbon atom and binds, through the carbon atom, to a carbon atom to which the substituent substitutes.

In an embodiment, in formula (1), each of U, V, X, Y, W and Z independently denotes an alkyl group.

In an embodiment, in formula (1), n denotes 2.

In an embodiment, the above carbon black composition further comprises a resin.

In an embodiment, the resin comprises a resin selected from the group consisting of polyurethane and a vinyl copolymer.

In an embodiment, the solvent comprises a ketone solvent.

In an embodiment, the carbon black composition is employed as a coating composition for forming a magnetic recording medium, for example, for forming a nonmagnetic layer or a backcoat layer of a magnetic recording medium or employed for preparation thereof.

In an embodiment, in formula (1), all of U, V, X, Y, W and Z denote a methyl group.

A further aspect of the present invention relates to a carbon black-containing coating film, which has been obtained by drying the above carbon black composition.

A still further aspect of the present invention relates to a magnetic recording medium comprising a magnetic layer containing a ferromagnetic powder and a binder on a nonmagnetic support, which comprises the above carbon black-containing coating film.

In an embodiment, the carbon black-containing coating film is a nonmagnetic layer positioned between the nonmagnetic support and the magnetic layer.

In an embodiment, the carbon black-containing coating film is a backcoat layer positioned on a surface of the nonmagnetic support opposite from a surface on which the magnetic layer is positioned.

An aspect of the present invention can provide a carbon black composition in which carbon black is highly dispersed in solvent. The above carbon black composition is useful in coating liquids for particulate magnetic recording media, print inks, and the like.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

### Carbon Black Composition

The carbon black composition according to an aspect of the present invention comprises the amine compound denoted by formula (1) below in a solvent. As set forth above, in the amine compound denoted by formula (1), the present inventors presume that the high bulk of the substituent substituted onto the nitrogen atom contained in a secondary amino group is why the above amine compound can enhance the dispersion of carbon black in solvent.

The carbon black composition according to an aspect of the present invention will be described in greater detail below.

The amine compound that is contained in the carbon black composition according to an aspect of the present invention is a diamine having the secondary amino group denoted by formula (1) below.

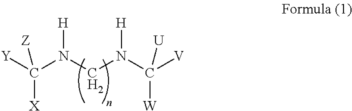

In formula (1), n denotes an integer falling within a range of 2 to 4. From the perspective of solubility, 2 or 3 is desirable, and 2 is preferred.

In formula (1), the substituent denoted by each of U, V, X, and Y is a substituent (also referred to hereinafter as a “carbon-containing substituent”) that contains at least one carbon atom and binds, through the carbon atom, to a carbon atom to which the substituent substitutes. That is, in formula (1), the carbon atom bonding with the nitrogen atom in the secondary amino group is at least a secondary carbon atom (there are at least two adjacent carbon atoms). Thus, the substituents (—C(UVW) and —C(XYZ) in formula (1)) thus substituted on the nitrogen atom can be of high bulk and impart high steric hindrance, thereby enhancing the dispersion of carbon black in solvent.

In formula (1), the plurality of carbon-containing substituents that are contained can be of identical or different structures. The carbon-containing substituents can include, by way of example, secondary amine structures, tertiary amine structures, ether structures, hydroxyl groups, and vinyl structures. They can also include cyclic structures such as five-membered and six-membered rings.

Examples of carbon-containing substituents are linear and branched saturated and unsaturated hydrocarbon groups. The above hydrocarbon groups can have substituents. Examples of such substituents are alkyl groups (such as alkyl groups having 1 to 6 carbon atoms), hydroxyl groups, alkoxyl groups (such as alkoxyl groups having 1 to 6 carbon atoms), halogen atoms (such as fluorine, chlorine, and bromine atoms), and aryl groups (such as phenyl groups). The “number of carbon atoms” when a substituent is present means the number of carbon atoms of the portion without the substituent. In the present invention, the word “to” denotes a range including the number given before it and one given after it as a minimum value and maximum value, respectively.

From the perspective of enhancing dispersion, the hydrocarbon group is desirably an alkyl group; for example, a linear or branched alkyl group having 1 to 18 carbon atoms. The alkyl group can be substituted or unsubstituted.

The number of carbon atoms of the alkyl group desirably falls within a range of 1 to 10, preferably within a range of 1 to 8, more preferably within a range of 1 to 5, and still more preferably, within a range of 1 to 3. Even more preferably, the carbon-containing substituent is a methyl group or an ethyl group, preferably a methyl group.

In formula (1), each of W and Z independently denotes a hydrogen atom or a substituent. Each of W and Z can contain a secondary amine structure, tertiary amine structure, ether structure, hydroxyl group, vinyl structures, or the like, and can contain a cyclic structure such as a five-membered or six-membered ring.

To achieve even better dispersion by further increasing the bulk of the substituent bonded to the nitrogen atom in the secondary amino group, at least either W or Z is desirably a substituent (carbon-containing substituent) that contains at least one carbon atom and binds, through the carbon atom, to a carbon atom to which the substituent substitutes. It is preferable for both W and Z to be carbon-containing substituents, that is, for the carbon atom bonding to the nitrogen atom in the secondary amino group of formula (1) to be a tertiary carbon atom (with three adjacent carbon atoms being present). Details regarding the carbon-containing substituents denoted by W and Z are as set forth for the carbon-containing substituents denoted by U, V, X, and Y above.

Specific examples of amine compounds denoted by above-described formula (1) include the diamine given below. The amine compounds denoted by formula (1) can be synthesized by known methods and are available as commercial products.

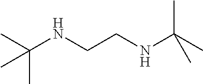

The carbon black that is contained in the carbon black composition according to an aspect of the present invention is not specifically limited. It can be selected for use based on the application from among various carbon blacks such as furnace black for rubber, thermal for rubber, black for coloring, electrically conductive carbon black, acetylene black. With regard to carbon black suitable for use in the present invention, reference can be made to the Carbon Black Handbook (compiled by the Carbon Black Association, which is expressly incorporated herein by reference in its entirety, for example.

For example, in a particulate magnetic recording medium, carbon black can be mixed into the nonmagnetic layer to achieve the known effect of reducing surface resistivity Rs and optical transmittance, and achieving a desired micro-Vicker's hardness. A lubricant stockpiling effect can also be achieved by incorporating carbon black into the nonmagnetic layer. The specific surface area of the carbon black that is employed in the nonmagnetic layer is normally 50 to 500 m²/g, desirably 70 to 400 m²/g, and the DBP oil absorption capacity is normally 20 to 400 mL/100 g, desirably 30 to 400 mL/100 g. The average primary particle diameter of the carbon black that is employed in the nonmagnetic layer is normally 5 to 80 nm, desirably 10 to 50 nm, and preferably, 10 to 40 nm.

The surface resistance and light transmittance of the backcoat layer can be set low by adding microparticulate carbon black to the backcoat layer of a particulate magnetic recording medium. Since many magnetic recording devices utilize the light transmittance of the tape for an operating signal, adding microparticulate carbon black is particularly effective in such cases. In the microparticulate carbon black that is employed in the backcoat layer, it is desirable for the average primary particle diameter to fall within a range of 5 to 30 nm, the specific surface area to fall within a range of 60 to 800 m²/g, the DBP oil absorption capacity to fall within a range of 50 to 130 mL/100 g, and the pH to fall within a range of 2 to 11.

Reference can be made to, for example, paragraphs [0033] and [0053] of Japanese Patent No. 4,149,648, which is expressly incorporated herein by reference in its entirety, for details on the above carbon blacks.

The carbon black composition according to an aspect of the present invention can also be employed to form the magnetic layer of a particulate magnetic recording medium. For details regarding the carbon black that is contained in the magnetic layer, reference can be made to paragraph [0067] of Japanese Patent No. 4,149,648.

The carbon black composition according to an aspect of the present invention can be used as a coating composition for forming a particulate magnetic recording medium or to prepare the coating composition by incorporating the above carbon black, the amine compound denoted by formula (1), and various optionally added components. For example, the carbon black composition can be employed as a coating composition for forming the nonmagnetic layer or backcoat layer of a particulate magnetic recording medium, or to prepare such a coating composition, and thus obtain a particulate magnetic recording medium having a nonmagnetic layer or a backcoat layer with highly dispersed carbon black.

The above carbon black is also suitable for use as a pigment in print ink. The carbon black composition according to an aspect of the present invention containing such carbon black can be suitably employed as a black ink in various types of printing such as ink-jet printing, offset printing, and gravure printing.

From the perspective of further enhancing the dispersion of carbon black, the amine compound denoted by formula (1) is desirably employed in a proportion of 1 to 50 weight parts, preferably 1 to 20 weight parts, per 100 weight parts of carbon black. For the same reason, the total quantity of solvent relative to carbon black is desirably 100 to 5,000 weight parts per 100 weight parts of carbon black in the carbon black composition according to an aspect of the present invention.

One or a combination of two or more of the amine compounds denoted by formula (1) can be employed in the carbon black composition according to an aspect of the present invention.

From the perspective of dispersing carbon black to a high degree by using it in combination with the amine compound denoted in formula (1), the solvent that is contained in the carbon black composition according to an aspect of the present invention desirably comprises a ketone solvent, preferably comprises equal to or more than 50 weight percent of a ketone solvent per the total weight of the solvent, and can be 100 percent ketone solvent. Examples of ketone solvents are ketones such as acetone, methyl ethyl ketone, methyl isobutyl ketone, diisobutyl ketone, cyclohexanone, isophorone, and tetrahydrofuran. Examples of solvents other than ketone solvents are various solvents such as alcohol solvents, ether solvents, and ester solvents. These solvents can be employed singly or combined in groups of two or more in any ratio for use.

Ketone solvents are generally readily available. They also have relatively low boiling points, are highly safe, and are easy to handle. Thus, ketone solvents are widely employed in various fields such as the magnetic recording field, printing field, and cosmetic field. The carbon black composition according to an aspect of the present invention containing a solvent in the form of a ketone solvent is useful in these various fields.

One known common method of raising the dispersion of microparticles is the method of covering the surface of the microparticles with a resin (binder). However, in the carbon black composition according to an aspect of the present invention, by containing the amine compound denoted by formula (1), a high state of carbon black dispersion can be achieved without combining the use of a resin. Specifically, even when the carbon black composition according to an aspect of the present invention does not contain a resin, a state of high dispersion of carbon black with a particle diameter in liquid as measured by the dynamic light scattering method, for example, of equal to or less than 150 nm, desirably equal to or less than 70 nm, and preferably, equal to or less than 50 nm, can be achieved.

In this context, the term “particle diameter in liquid as measured by the dynamic light scattering method” is an index of the state in which the carbon black is present in the carbon black composition according to an aspect of the present invention, that is, the state of dispersion. The lower the value, the better the state of dispersion in a state approximating primary particles without the carbon black undergoing aggregation that is achieved. Measurement by the dynamic light scattering method can be conducted with an LB-500 dynamic light scattering particle size analyzer made by Horiba. The particle diameter in liquid can also be measured by dilution with the liquid that is to be measured to enhance measurement precision. In that case, to further enhance measurement precision, it is desirable to employ a solvent that is contained in the liquid that is to be measured as the diluting solvent, and preferable to use the same solvent as the liquid to be measured.

The carbon black can be dispersed to an even higher degree by incorporating a resin into the carbon black composition according to an aspect of the present invention. By combining a resin, the carbon black can be dispersed to an extremely high state of dispersion of a particle diameter in liquid of equal to or less than 50 nm, even equal to or less than 40 nm. Regardless of whether or not a resin is employed, the lower limit of the particle diameter in liquid is the primary particle diameter or average primarily particle diameter of the carbon black.

Examples of binder resins that can be employed are polyurethane resin, polyester resin, polyamide resin, vinyl chloride resin, acrylic resins obtained by copolymerizing styrene, acrylonitrile, methyl methacrylate, or the like, cellulose resins such as nitrocellulose, epoxy resin, phenoxy resin, and polyvinyl alkyral resins such as polyvinyl acetal and polyvinyl butyral. Of these, vinyl copolymers and polyurethane resins are employed with preference. The resin can be employed in a proportion of 1 to 100 weight parts per 100 weight parts of carbon black, for example.

The carbon black composition according to an aspect of the present invention can contain an isocyanate compound along with the above resin. The isocyanate compound is a component that can form a crosslinked structure with the resin as a curing agent, thereby contributing to enhancing coating strength.

It is desirable to employ a bifunctional or greater, preferably a trifunctional or greater, isocyanate compound (polyisocyanate). An isocyanate compound the use of which as a curing agent in particulate magnetic recording media is known can be employed in a proportion of 5 to 100 weight parts per 100 weight parts of resin.

The carbon black compound according to an aspect of the present invention can contain various known additives that are employed based on the application.

The average particle size of powders such as carbon black in the present invention can be measured by the following method.

Particles of powder are photographed at a magnification of 100.000-fold with a model H-9000 transmission electron microscope made by Hitachi and printed on photographic paper at a total magnification of 500.000-fold to obtain particle photographs. The targeted particle is selected from the particle photographs, the contours of the particle are traced with a digitizer, and the size of the particles is measured with KS-400 image analyzer software from Carl Zeiss. The size of 500 particles is measured. The average value of the particle sizes measured by the above method is adopted as an average particle size of the powder.

The size of a powder (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method. As in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

The average powder size of the powder is the arithmetic average of the above powder size and is calculated by measuring five hundred primary particles in the above-described method. The term “primary particle” refers to a nonaggregated, independent particle.

The carbon black composition according to an aspect of the present invention can be prepared by simultaneously or sequentially admixing the above-described amine compound, carbon black, and solvent with various optional additives.

The carbon black composition according to an aspect of the present invention can be employed in various fields requiring a high degree of carbon black dispersion, such as particulate magnetic recording media, ink for printing, paint, cosmetics, and batteries. For example, the carbon black composition according to an aspect of the present invention can be employed as is, or by adding various additives employed in magnetic recording media, as a coating composition for forming a magnetic recording medium. The coating composition can be employed, for example, to form a nonmagnetic layer or backcoat layer.

A further aspect of the present invention relates to a carbon black-containing coating film obtained by drying the carbon black composition according to an aspect of the present invention.

The carbon black composition according to an aspect of the present invention as set forth above can contain carbon black in a highly dispersed state in solvent. Thus, the above composition can be coated on a support and dried, for example, to obtain a coating film free of surface roughness due to the aggregation of carbon black, and having good surface smoothness. One embodiment of the coating film according to an aspect of the present invention is the backcoat layer, nonmagnetic layer, magnetic layer, and the like of a magnetic recording medium. However, there is no limitation thereto, and various embodiments of use, such as in antistatic sheets, are also possible.

A further aspect of the present invention relates to a magnetic recording medium having a magnetic layer comprising a ferromagnetic powder and a binder on a nonmagnetic support, which comprises a carbon black-containing coating film obtained by drying the carbon black composition according to an aspect of the present invention set forth above. The carbon black-containing coating film contained in the magnetic recording medium according to an aspect of the present invention normally contains a binder (resin). Details regarding the binder are as set forth above.

In one embodiment, the carbon black-containing coating film is a nonmagnetic layer positioned between a nonmagnetic support and a magnetic layer. In another embodiment, the carbon black-containing coating film is a backcoat layer positioned on the opposite surface of the nonmagnetic support from the magnetic layer. In still another embodiment, the carbon black-containing coating film is a magnetic layer. Details regarding the carbon black contained in the nonmagnetic layer, backcoat layer, and magnetic layer are as set forth above.

The nonmagnetic layer of a particulate magnetic recording medium contains a nonmagnetic powder and a binder. When the carbon black-containing coating film is the nonmagnetic layer of a particulate magnetic recording medium, the entire quantity of the nonmagnetic powder contained in the nonmagnetic layer can be carbon black, or the carbon black can be contained together with some other nonmagnetic powder.

In the layer configuration of the magnetic recording medium according to an aspect of the present invention, the nonmagnetic support is desirably 3 to 80 μm in thickness. The thickness of the magnetic layer can be optimized based on the saturation magnetization level of the magnetic head employed, the head gap length, and the recording signal bandwidth. From the perspective of achieving a high capacity, it is desirably 10 to 100 nm, preferably 20 to 80 nm. It suffices to have at least one magnetic layer. It can be divided into two or more magnetic layers of differing magnetic characteristics. Any known multilayered magnetic layer structure can be applied. The thickness of the nonmagnetic layer is desirably 0.6 to 3.0 μm, preferably 0.6 to 2.5 μm, and more preferably, 0.6 to 2.0 μm. The thickness of the backcoat layer is desirably equal to or less than 0.9 μm, preferably 0.1 to 0.7 μm.

When the magnetic recording medium according to an aspect of the present invention has a nonmagnetic layer, the nonmagnetic layer will produce its effect so long as it is essentially nonmagnetic. The effect of the present invention will be achieved even if impurities or small quantities of magnetic material are intentionally incorporated into the nonmagnetic layer, and such configurations can be viewed as being essentially identical to the magnetic recording medium according to an aspect of the present invention. The term “essentially identical” means that the residual flux density of the nonmagnetic layer is equal to or less than 10 mT (100 G) and the coercivity is equal to or less than 7.96 kA/m (100 Oe), and desirably means that no residual flux density or coercivity is present.

In the magnetic recording medium according to an aspect of the present invention, at least one layer is the above-described carbon black-containing coating film. With this exception, known techniques regarding magnetic recording media can be applied without limitation.

### EXAMPLES

The present invention will be described in detail below based on Examples. However, the present invention is not limited to the examples.

### 1. Example of Carbon Black Composition not Containing Resin

### Example 1

A 1.0 weight part quantity of the carbon black below and 0.030 weight part of di-tert-butylethylene diamine were suspended in a solution comprised of 12 weight parts of methyl ethyl ketone and 8 weight parts of cyclohexanone. To this suspension were added 120 g of 0.1 mm φ zirconia beads (made by Nikkato) and the mixture was dispersed for 15 hours, yielding a carbon dispersion. The diameter (particle diameter in liquid by the dynamic light scattering method) of the dispersed particles was measured by the method set forth further below, revealing 35 nm, approximately a primary particle diameter value. Based on the result, it can be determined that the dispersion of carbon black in solvent was enhanced by the above amine.

Carbon black: #950, made by Mitsubishi Chemical Corp.

Average primary particle diameter: 18 nm

Specific surface area by nitrogen adsorption method: 260 m²/g

DBP oil absorption capacoty: 79 mL/100 g (powder form) pH: 7.5

Method of measuring diameter of dispersed particles (particle diameter in liquid by dynamic light scattering method)

An organic solvent identical to that employed for the carbon dispersion was employed to dilute the solid fraction concentration to 0.2 weigh percent (the solid fraction denotes the combined weight of the carbon black and amine additives (including the resin in the resin-containing system described further below)).

The average particle diameter in the diluted solution obtained as measured with an LB-500 dynamic light scattering particle size distribution measuring apparatus made by Horiba was adopted as the dispersed particle diameter. The smaller the dispersed particle diameter, the better the dispersion of the carbon black without aggregation indicated.

### 2. Example and Comparative Examples of Binder Resin-Containing Carbon Black Composition and Coating Film

### Example 2

A 1.0 weight part quantity of the carbon black employed in Example 1, 0.030 weight part of di-tert-butylethylene diamine, 0.41 weight part of vinyl chloride resin (MR104 made by Zeon Corporation), and 0.25 weight part of polyether polyurethane were suspended in a solution comprised of 12 weight parts of methyl ethyl ketone and 8 weight parts of cyclohexanone. To this suspension were added 120 g of 0.1 mm φ zirconia beads (made by Nikkato) and the mixture was dispersed for 15 hours, yielding a carbon dispersion. The diameter (particle diameter in liquid by the dynamic light scattering method) of the dispersed particles was measured by the method set forth above, revealing a value of 30 nm.

The above carbon dispersion was coated on a PEN base made by Teijin using a doctor blade with a 19 μm gap and dried by standing at room temperature for 30 minutes to prepare a coating film. The average roughness of the coating prepared as measured by the method set forth below was 1.9 nm.

Method of Measuring Surface Roughness (Coating Film Smoothness)

A NewView 5022 general-purpose three-dimensional surface structure analyzer made by Zygo was used to measure the surface roughness of the coating film by the scanning white light interference method at a scan length of 5 μm. The objective lens was 20-fold, the intermediate lens was 1.0-fold, and the measurement viewing field was 260 μm×350 μm. The measured surface was filter-processed with an HPF: 1.65 μm and LPF: 50 μm filter to obtain the value of the centerline average surface roughness Ra.

### Comparative Examples 1 to 3

With the exception that the types and quantities of amines shown in Table 1 were employed, carbon black dispersions and coating films were prepared and evaluated in the same manner as in Example 2.

The above results are given in Table 1.

TABLE 1

| | | Quantity | | |
|---|---|---|---|---|
| | | of amine | | |
| | | (weight | Dis- | |
| | | part/ | persed | Surface |
| | | 1 weight | Particle | rough- |
| | | part of | Di- | ness |
| | | carbon | ameter | Ra |
| | Type of amine | black) | (nm) | (nm) |
| Ex. 2 | 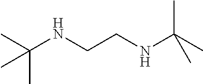 | 0.030 | 30 | 1.9 |
| Comp. Ex. 1 | 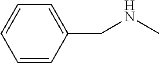 | 0.021 | 63 | 2.5 |
| Comp. Ex. 2 | 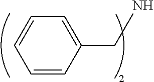 | 0.033 | 59 | 2.7 |
| Comp. Ex. 3 | 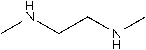 | 0.015 | 55 | 2.8 |

Evaluation of Amine Reactivity

The reactivity of the amine compounds employed in Examples 1 and 2 with respect to cyclohexanone and methyl ethyl ketone was evaluated by the following method.

An amine compound and solvent (cyclohexanone or methyl ethyl ketone) were weighed out in equimolar amounts, mixed together, and placed for 1 hour in a 50° C. oven. Subsequently, they were removed from the oven, dissolved in a heavy solvent in the form of CDCl₃, and measured by NMR. When a peak differing from the solvent-derived peak and amine-derived peak was found in the NMR spectrum, reactivity was determined to be present. When the reactivity of amine compounds and solvents was evaluated, the amine compounds employed in Examples 1 and 2 were found to exhibit no reactivity to cyclohexanone or methyl ethyl ketone.

By contrast, the same evaluation as above was conducted for the amine compounds employed in Comparative Examples 2 and 3, revealing that both amine compounds exhibited reactivity to cyclohexanone and methyl ethyl ketone.

The results given in Table 1 indicated that the use of the amine compound denoted by formula (1) dispersed carbon black to a high degree in solvent. They also indicated that this formed a carbon black-containing coating film having good surface smoothness.

The fact that the amine compounds denoted by formula (1) had poor reactivity with solvents was attributed to an enhanced dispersion property.

### 3. Example and Comparative Example of Magnetic Recording Medium

The “parts” given below denote “weight parts.”

### Example 3

### Formula of Coating Composition for Forming Magnetic Layer

Ferromagnetic plate-shaped hexagonal ferrite powder: 100 parts
Composition excluding oxygen (mole ratio): Ba/Fe/Co/Zn=1/9/0.2/1
Hc: 183 kA/m (2,300 Oe), plate diameter: 25 nm, plate ratio: 3
Specific surface area by BET method: 80 m²/g
σs: 50 A·m²/kg (50 emu/g)

Polyurethane resin (functional group: SO₃Na, functional group concentration: 70 eq/t) 8 parts

Vinyl chloride resin (functional group: —OSO₃K, functional group concentration: 70 eq/t): 14 parts

Oleic acid: 0.2 part

2,3-Dihydroxynaphthalene: 6 parts

α-Al₂O₃ (particle size: 0.15 μm): 5 parts

Carbon black (particle size: 100 nm): 2 parts

Cyclohexanone: 150 parts

Methyl ethyl ketone: 150 parts

Butyl stearate: 2 parts

Stearic acid: 1 part

Stearic acid amide: 0.1 part

Formula of coating composition for forming nonmagnetic layer

Carbon black: 100 parts
DBP oil absorption capacity: 100 mL/100 g
pH: 8
Specific surface area by BET method: 250 m²/g
Volatile content: 1.5 percent

Polyurethane resin (functional group: —SO₃Na, functional group concentration: 70 eq/t): 20 parts

Vinyl chloride resin (functional group: —OSO₃K, function group concentration: 70 eq/t): 30 parts

Di-tert-butylethylene diamine: 2 parts

Cyclohexanone: 140 parts

Methyl ethyl ketone: 170 parts

Butyl stearate: 2 parts

Stearic acid: 2 parts

Stearic acid amide: 0.1 part

For each of the above coating composition for forming a magnetic layer and coating composition for forming a nonmagnetic layer, the various components were knead for 60 minutes in an open kneader and then subsequently dispersed for 720 minutes in a sand mill employing zirconia beads (average particle diameter: 0.5 mm). The dispersion liquids obtained were filtered using a filter having an average pore diameter of 1 μm to prepare coating compositions for forming the various layers.

The coating composition for forming a nonmagnetic layer was coated to 1.5 μm on a nonmagnetic support and dried at 100° C. Immediately thereafter, the coating composition for forming a magnetic layer was coated wet-on-dry in a quantity calculated to yield a thickness of 0.08 μm upon drying and dried at 100° C. During this process, while the magnetic layer had not yet dried, magnetic field orientation was conducted with a 300 mT (3,000 gauss) magnet. A surface smoothing treatment was conducted at a temperature of 90° C., a linear pressure of 300 kg/cm, and a rate of 100 m/min with a seven-stage calender comprised of only metal rolls. Subsequently, a heat curing treatment was conducted for 24 hours at 70° C. and the product was slit to a ½ inch width to prepare a magnetic tape.

The surface roughness of the magnetic layer of the magnetic tape obtained was measured by the method set forth above at 1.5 nm.

### Comparative Example 4

With the exception that two parts of the di-tert-butylethylene diamine in the coating composition for forming a nonmagnetic layer were replaced with two parts of the amine compound employed in Comparative Example 3, a magnetic tape was prepared by the same method and the surface roughness of the magnetic layer thereof measured by the same method as in Example 3, revealing a surface roughness of 2.5 nm.

The surface smoothness of the magnetic layer greatly impacts electromagnetic characteristics and running stability. The surface smoothness of the magnetic layer in Example 3 was much improved over that of Comparative Example 4. This was due to the good dispersion of the nonmagnetic powder (carbon black) in the nonmagnetic layer positioned under the magnetic layer.

Further, a backcoat layer can be also formed with the same formula as the coating composition for forming a nonmagnetic layer set forth above. Based on the above Example results, the carbon black was determined to have dispersed well in the backcoat layer thus formed.

The present invention is useful in various fields such as the magnetic recording field, print field, and cosmetic product field.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A carbon black composition, which comprises carbon black and an amine compound denoted by formula (1) in a solvent; 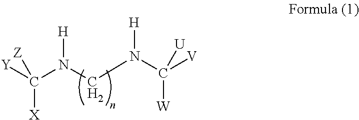
wherein, in formula (1), n denotes an integer falling within a range of 2 to 4, each of U, V, X, and Y independently denotes a substituent that comprises at least one carbon atom and binds, through the carbon atom, to a carbon atom to which the substituent substitutes, and each of W and Z independently denotes a hydrogen atom or a substituent.

2. The carbon black composition according to claim 1, wherein, in formula (1), each of W and Z independently denote a substituent that comprises at least one carbon atom and binds, through the carbon atom, to a carbon atom to which the substituent substitutes.

3. The carbon black composition according to claim 1, wherein, in formula (1), each of U, V, X, Y, W and Z independently denotes an alkyl group.

4. The carbon black composition according to claim 1, wherein, in formula (1), n denotes 2.

5. The carbon black composition according to claim 1, wherein, in formula (1), each of U, V, X, Y, W and Z independently denotes an alkyl group, and n denotes 2.

6. The carbon black composition according to claim 1, which further comprises a resin.

7. The carbon black composition according to claim 6, wherein the resin comprises a resin selected from the group consisting of polyurethane and a vinyl copolymer.

8. The carbon black composition according to claim 5, wherein the solvent comprises a ketone solvent.

9. The carbon black composition according to claim 1, wherein, in formula (1), all of U, V, X, Y, W and Z denote a methyl group.

10. The carbon black composition according to claim 1, wherein, in formula (1), all of U, V, X, Y, W and Z denote a methyl group, and n denotes 2.

11. The carbon black composition according to claim 10, which further comprises a resin.

12. The carbon black composition according to claim 11, wherein the resin comprises a resin selected from the group consisting of polyurethane and a vinyl copolymer.

13. The carbon black composition according to claim 10, wherein the solvent comprises a ketone solvent.

14. The carbon black composition according to claim 1, which further comprises a resin.

15. The carbon black composition according to claim 14, wherein the resin comprises a resin selected from the group consisting of polyurethane and a vinyl copolymer.

16. The carbon black composition according to claim 1, wherein the solvent comprises a ketone solvent.

17. A carbon black-containing coating film, which has been obtained by drying the carbon black composition according to claim 1.

18. A magnetic recording medium comprising a magnetic layer containing a ferromagnetic powder and a binder on a nonmagnetic support, which comprises the carbon black-containing coating film according to claim 17.

19. The magnetic recording medium according to claim 18, wherein the carbon black-containing coating film is a nonmagnetic layer positioned between the nonmagnetic support and the magnetic layer.

20. The magnetic recording medium according to claim 18, wherein the carbon black-containing coating film is a backcoat layer positioned on a surface of the nonmagnetic support opposite from a surface on which the magnetic layer is positioned.
